(19) United States
(12) Patent Application Publication
(10) Pub. No.: US 2009/0166478 A1
(43) Pub. Date: Jul. 2, 2009

(54) Apparatus for Controlling Cable of Robot

(76) Inventor: Kwang Sul Choi, Ulsan (KR)

Correspondence Address: THE NATH LAW GROUP, 112 South West Street, Alexandria, VA, 22314, US

(21) Appl. No.: 12/085,451

(22) PCT Filed: Mar. 27, 2007
(86) PCT No.: PCT/KR2007/001494

§ 371 Date: Jun. 12, 2008

(30) Foreign Application Priority Data
Mar. 28, 2006 (KR) 10-2006-0027916

(51) Int. Cl. F16L 3/01; F16L 3/00

(52) U.S. Cl. 248/51; 901/49

(57) ABSTRACT

Provided is an apparatus for controlling cables of a robot. The cable control apparatus includes: a body disposed above the arm and having a male rail formed in a length direction; a stationary unit fixed at an upper one side of the body and having a through-hole; a moving unit disposed on the male rail slidably in right and left directions and including a through-hole formed thereon and a female rail corresponding to the male rail; a cable tube for integrally housing a plurality of the cables and including one end fixed to the moving unit and the other end connected to the head through the through-hole of the stationary unit; and an elastic member externally inserted to the cable tube and including one end connected to the stationary unit and the moving unit.

### TECHNICAL FIELD

The present invention related to an apparatus for controlling cables of a robot, and more particularly, to a cable control apparatus for sustaining cables of an industrial robot not to be loosen.

### BACKGROUND ART

In general, an industrial robot 10 includes an arm 1 for making various motions and a head 2 disposed at one end of the arm for mounting various tools as shown in FIGS. 1 to 3. Furthermore, the industrial robot 10 includes a plurality of cables 4 disposed along the outside of the arm and connected to the head in order to supply electric power or control signals. For example, the cables include a power cable, a control cable, and a water cable.

Although the industrial robot 10 is controlled through a plurality of the cables 4, the cables disturb the arm 1 4 to make certain motions because the cables are disposed along the outside of the arm 1. In order to prevent the cables 4 from disturbing the arm 1 to make motions, a cable tube 3 was used. That is, the cables disposed between the arm and the head are combined into the cable tube, and the cables are disposed along the arm with the cable tube not to disturb the operation of the robot 10 with in an operating radius of the robot 10.

The length of the cable tube 3 of the industrial robot 10 varies according the motion of the head 2. When the head 2 connected to the arm 1 of the industrial robot 10 is in an initial state before a rotation motion is made as shown in FIG. 1, the cable tube 4 is strained without being loosen. When the industrial robot 1 rotates the head 2, the cable tube 3 between the arm 1 and the head 2 becomes loosen because the cable tube 3 is pulled to the head 2 as long as a radius of the rotation motion.

When the conventional robot 10 rotates the head 2, the cable tube 3 disposed between the head 2 and the arm 1 is pulled to the head 2. However, the cable tube 3 is not restored to an original state after the cable tube 3 between the head 2 and the arm 1 is pulled to the head 2. Therefore, the cable tube 3 between the head 2 and the arm 1 becomes loosen. The loosen cable tube 3 is entangled or bended when the industrial robot 10 operates. Therefore, the cables in the entangled or bended cable tube may be damaged.

### DISCLOSURE OF INVENTION

### Technical Problem

It is, therefore, an object of the present invention to provide a cable control apparatus for preventing a plurality of cables rotatably connected to an arm and a head of an industrial robot from being loosen not to be entangled or bended, thereby preventing the cables from being damaged.

### Technical Solution

In accordance with one aspect of the present invention, there is a cable control apparatus for preventing a plurality of cables, which are rotatably connected to an arm and a head of an industrial robot, from being loosen or damaged by the operation of the head, the cable control apparatus including: a body disposed above the arm and having a male rail formed in a length direction; a stationary unit fixed at an upper onside of the body and having a through-hole; a moving unit disposed on the male rail slidably in right and left directions and including a through-hole formed thereon and a female rail corresponding to the male rail; a cable tube for integrally housing a plurality of the cables and including one end fixed to the moving unit and the other end connected to the head through the through-hole of the stationary unit; and an elastic member externally inserted to the cable tube and including one end connected to the stationary unit and the moving unit for returning the moving unit to an original position using elastic force when the head of the industrial robot slides the moving unit connected to the cable tube.

A rail protrusion may be formed on the male rail in a length direction and a rail groove may be formed on a bottom side of the arm rail in a length direction to be corresponding to the rail protrusion.

One or more male rails may be disposed above a bottom side of the body at a pre-determined distance, and the female rail may include at least one of through-holes formed under the female rail to slidably move while surrounding a cross-section of the male rail.

The elastic member may be a spring.

The cable control apparatus may further include a sub stationary unit disposed at an upper one side of the body and having a through-hole, and the sub station unit may make a plurality of the cables to be bended in about a ‘U’ shape after the cables pass through the stationary unit and the moving unit straightly in order to prevent the cables from being shaken by the operation of the head.

In accordance with another aspect of the present invention, there is a cable control apparatus for preventing a plurality of cables, which are rotatably connected to an arm and a head of an industrial robot, from being loosen or damaged by the operation of the head, the cable control apparatus including: a body disposed above the arm and having a male rail formed in a length direction; a stationary unit fixed at an upper onside of the body; a moving unit disposed on the male rail slidably in right and left directions and including a through-hole formed thereon and a female rail corresponding to the male rail; a cable tube for integrally housing a plurality of the cables and including one end fixed to the moving unit and the other end connected to the head of the industrial robot; a supporting member fixed at an upper one side of the body and having a through-hole to allow the cable tube to pass through; and an elastic member including one end connected to the stationary unit and the moving unit for returning the moving unit to an original position using elastic force when the head of the industrial robot slides the moving unit connected to the cable tube.

### Advantageous Effects

A cable control apparatus according to the present invention restores deformed loosen cables by the operation of a head, for example, entangled or bended cables, to an original state using an elastic member. Therefore, the cables are prevented from being damaged, the life time of the cables extends, and a maintenance cost can be saved.

As described above, although the present invention has been described and illustrated with reference to preferred embodiments and drawings, it should be understood that various modifications and variations of the present invention can be made thereto by those skilled in the art without departing from the spirit and the technical scope of the present invention as defined by the appended claims.

### BRIEF DESCRIPTION OF THE DRAWINGS

The above and other objects and features of the present invention will become apparent from the following description of the preferred embodiments given in conjunction with the accompanying drawings, in which:

FIGS. 1 through 3 are front views of a cable control apparatus according to the related art;

FIG. 4 is a perspective view of a cable control apparatus of an industrial robot according to an embodiment of the present invention;

FIG. 5 is a front view of an industrial robot having the cable control apparatus of FIG. 4;

FIG. 6 is a perspective view illustrating a cable control apparatus of FIG. 4 in operation;

FIG. 7 is a perspective view illustrating a male rail of FIG. 4 with a brace for preventing a moving from being derailed from a mail rail;

FIG. 8 is a perspective view illustrating a female rail and a mail rail of FIG. 4 according to another embodiment of the present invention;

FIG. 9 is a perspective view illustrating a cable control apparatus of an industrial robot according to another embodiment of the present invention; and

FIG. 10 is a perspective view illustrating a controller of FIG. 9 in operation.

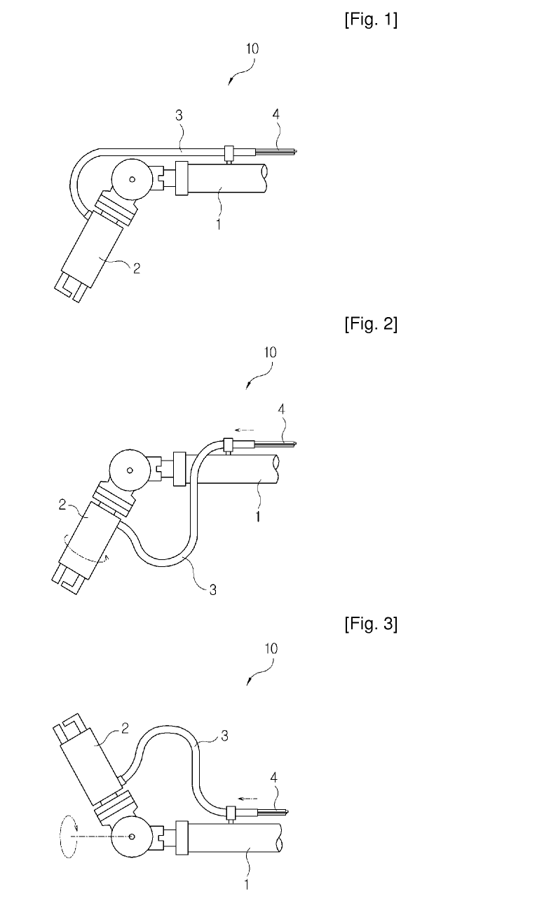

### BEST MODE FOR CARRYING OUT THE INVENTION

Other objects and aspects of the invention will become apparent from the following description of the embodiments with reference to the accompanying drawings, which is set forth hereinafter.

The present invention relates to a cable control apparatus for preventing a plurality of cables rotatably connected to an arm and a head of an industrial robot from being loosen not to be entangled or bended, thereby preventing the cables from being damaged.

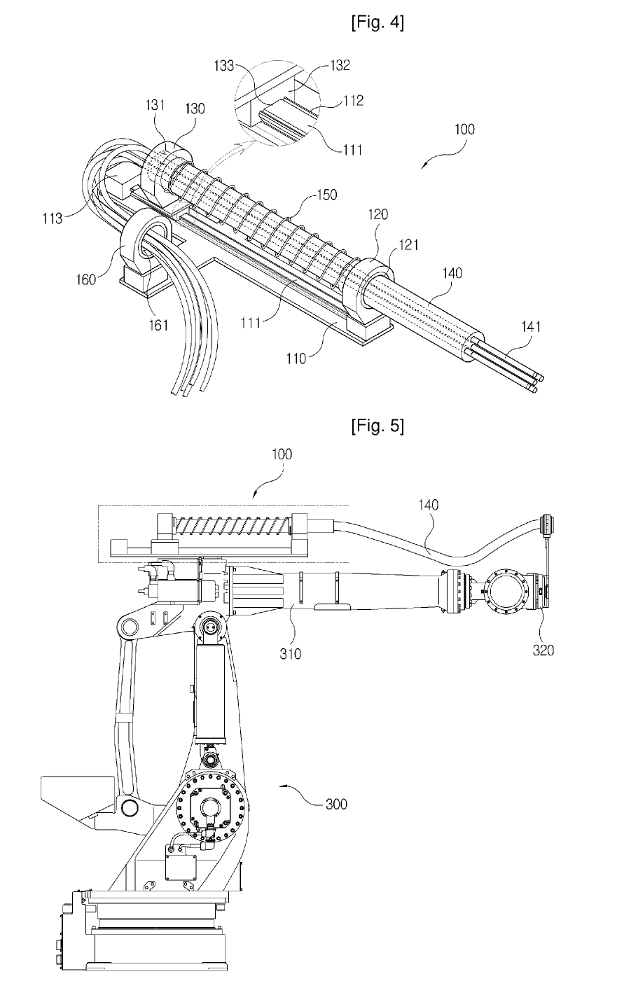

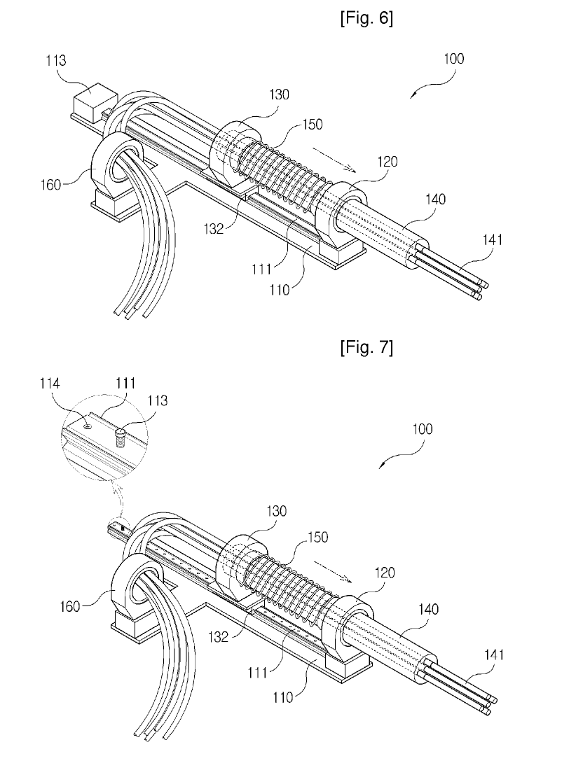

FIG. 4 is a perspective view of a cable control apparatus of an industrial robot according to an embodiment of the present invention, FIG. 5 is a front view of an industrial robot having the cable control apparatus of FIG. 4, and FIG. 6 is a perspective view illustrating a cable control apparatus of FIG. 4 in operation.

As shown, the cable control apparatus 100 according to the present embodiment includes a body 110, a stationary unit 120, a moving unit 130, a cable tube 140, and an elastic member 150.

The body 110 is fixed above the arm 310, and a mail rail 111 is formed on the body 110 in a length direction. The body 110 supports the stationary unit 120 and the moving unit 130. A rail protrusion 112 may be formed on the mail rail 111 of the body 110 in a length direction.

The stationary unit 120 is fixed at one side of the body 110 to be adjacent to one end of the mail rail 111. The stationary unit 120 includes a through-hole 121 for allowing a cable tube 140 to pass through.

The moving unit 130 is disposed on the mail rail 111 slidably in left and right directions. The moving unit 130 includes a through-hole 131 formed thereon and a female rail 132 formed thereunder corresponding to the mail rail 111.

A rail groove 133 is formed on a bottom side of the female rail 132 in a length direction to be corresponding to the rail protrusion 112 of the male rail 111. The rail groove 133 enables the moving unit 130 to slide along the male rail 111.

The cable tube 140 is a pipe shaped member for integrally housing a plurality of the cables 141. The cable tube 140 includes one end fixed at the moving unit 130 and the other end connected to the head 320 of the industrial robot 300 after passing through the through-hole 121 of the stationary unit 120.

The elastic member 150 is externally inserted to the cable tube 140 and includes one end fixed to the stationary unit 120 and the other end fixed to the moving unit 130. The elastic member 150 returns the moving unit 130 to an original position using elastic force although the moving unit 130 connected to the cable tube 140 slides when the head 320 moves.

It is preferable that the elastic member 150 may be a spring having elastic force.

As the head 320 of the industrial robot 300 operates, the cable tube 140 is pulled toward the head 320. Then, the pulling power of the cable tube 140 contracts the elastic member 150 and the contracted elastic member 150 slides the moving unit 130 connected to the cable tube 140 as shown in FIG. 6. As the head 320 returns to an original position, the contracted elastic member 150 is released to an original state. Then, the moving unit 130 also returns to an original position as shown in FIG. 4. That is, the cable control apparatus according to the present embodiment sustains the cable tube 140 and the cables 141 not to be entangled or bended.

As described above, the cable control apparatus 100 according to the present embodiment returns the cables which are entangled or bended by the operation of the head 320 to the original state using the elastic member 150. Therefore, the cables 141 are prevented from being damaged, the life time of the cables extends, and a maintenance cost can be saved.

The cable control apparatus 100 according to the present embodiment further includes a sub stationary unit 160.

The sub stationary unit 160 is installed at an upper one side of the body 110 and includes a through-hole 161. The sub stationary unit 160 bends the cables in about a ‘U’ shape after the cables 141 pass straightly through the stationary unit 120 and the moving 130. That is, the sub stationary unit 160 prevents the cables 141 from being shaken by the operation of the head 320.

FIG. 7 is a perspective view illustrating a male rail of FIG. 4 with a brace for preventing a moving from being derailed from a mail rail.

The brace 113 is fixed at an upper one side of the body 110 to prevent the moving unit 130 from being derailed from the mail rail 111.

The brace 113 can be fixed to the body 110 as shown in FIGS. 4 and 6, or the brace 113 can be movable disposed, that is, selectively fixed at a plurality of guide grooves 114 formed on the male rail 111 of the body 110.

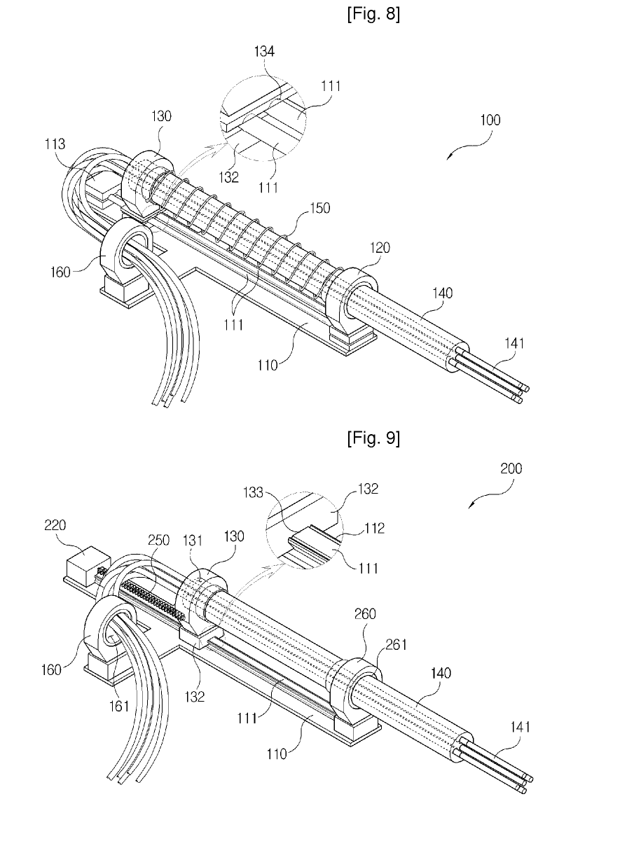

FIG. 8 is a perspective view illustrating a female rail and a mail rail of FIG. 4 according to another embodiment of the present invention.

As shown, one or more male rails 111 can be disposed above the bottom side of the body 110 at a predetermined distance. At least one of the female rails 132 can be formed to have a predetermined shape corresponding to the cross-section of the male rail 111 in order to enable the female rail 132 slides along the male rail 11 while surrounding the cross-section of the male rail 111.

The shape of the male rail 111's cross-section may be a circle as shown in FIG. 8. However, the cross-section shape is not limited thereto. The shape of the cross-section may vary to various shapes such as a polygon, a circle, and a shape combined with a polygon and a circle.

When single male rail 111 is disposed on the body 110, it is preferable that the cross-section of the male rail 111 has other shapes except a circle to prevent the moving unit 130 having the female rail 132 from being leaned toward one side.

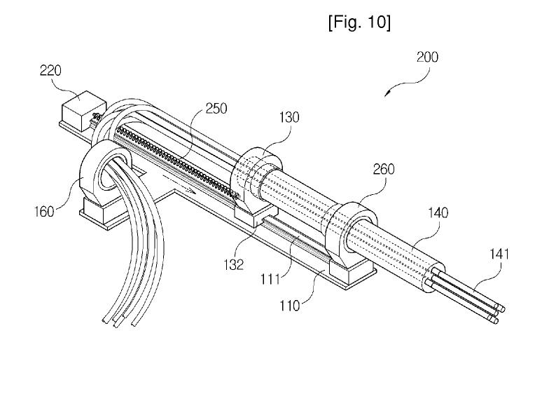

Hereinafter, a cable control apparatus of an industrial robot according to another embodiment of the present invention will be described with reference to FIGS. 9 and 10. FIG. 9 is a perspective view illustrating a cable control apparatus of an industrial robot according to another embodiment of the present invention, and FIG. 10 is a perspective view illustrating a controller of FIG. 9 in operation.

As shown, the cable control apparatus 200 according to another embodiment includes a body 110, a stationary unit 220, a moving unit 130, a cable tube 140, a supporting member 260, and an elastic member 250.

The body 110 is disposed above the arm 310, and the body 110 includes a male rail 111 formed thereon in a length direction. The body 110 supports the stationary unit 220, the moving unit 130 and the supporting member 260. A rail protrusion 112 is formed on the male rail 111 in a length direction.

The stationary unit 220 is fixed at an upper one side of the body 110, and one end of the stationary unit 220 is fixed at the stationary unit 220.

The moving unit 130 is disposed at on the male rail 111 slidably in right and left directions. The moving unit 130 includes a through-hole 131 for allowing the cables 141 to pass through and a female rail 132 formed thereunder to be corresponding to the male rail 111.

The rail groove 133 is formed on the bottom side of the female rail 132 to be corresponding to the rail protrusion 112 of the male rail 111. The rail groove 133 enables the moving unit 130 to slide on the male rail 111.

The cable tube 140 is a pipe shaped member for warping a plurality of cables. The cable tube 140 includes one end fixed to the moving unit 130 and the other end connected to the head 320 of the industrial robot 300 after passing through the supporting member 260 fixed at the moving unit 130.

The supporting member 260 is fixed at the upper one side of the body 110 and includes a through-hole 261 for allowing the cable tube 140 to pass through.

The elastic member 250 includes one end fixed to the stationary unit 220 and the other end fixed to the moving unit 130. The elastic member 250 returns the moving unit 130 to an original position using elastic force although the moving unit 130 connected to the cable tube 140 slides when the head 320 moves. It is preferable that the elastic member 150 may be a spring having elastic force.

As the head 320 of the industrial robot 300 operates, the cable tube 140 is pulled toward the head 320. Then, the pulling power of the cable tube 140 extends the elastic member 150 and the extended elastic member 150 slides the moving unit 130 connected to the cable tube 140 as shown in FIG. 10. As the head 320 returns to an original position, the elastic member 250 is contracted to an original state. Then, the moving unit 130 also returns to an original position as shown in FIG. 9. That is, the cable control apparatus according to another embodiment sustains the cable tube 140 and the cables 141 not to be entangled or bended.

As described above, the cable control apparatus 200 according to another embodiment returns the cables 141 which are entangled or bended by the operation of the head 320 to the original state using the elastic member 150. Therefore, the cables 141 are prevented from being damaged, the life time of the cables extends, and a maintenance cost can be saved.

The cable control apparatus of an industrial robot according to another embodiment further includes a sub stationary unit 160 for preventing the cables 141 from begin shaken by the operation of the head 320.

The male rail and the female rail shown in FIG. 8 can be identically applied to the cable control apparatus 200 according to another embodiment.

Hereinafter, the operation of cable control apparatuses 100 and 200 according to embodiments of the present invention will be described with reference to FIGS. 4 to 10.

The cable control apparatus 100 or 200 is housed in a predetermined case (not shown) and disposed above the arm 310 of the robot 300 as shown in FIG. 5. Also, one end of the cable tube 140 warping a plurality of cables is connected to the head 320.

When the robot 300 rotates the head 320, the head pulls the elastic member 150 or 250. The pulling power contracts or extends the elastic member 150 or 250 and the extended or contracted elastic member 150 or 250 slides the moving unit 130. Therefore, the moving unit 130 sustains the cable tube 140 not to be entangled or bended while the robot performs a predetermined operation.

When the head 320 returns to an initial position, the pulling force applied to the cable tube 140 is disappeared. Accordingly, the contracted or expanded elastic member 150 or 250 extends or contracts to the original state by the elastic force and the moving unit 130 returns to the original position. Therefore, the cable tube 140 and the cable 141 can be sustained not to be entangled or bended or return to the original position without being entangled or bended.

While the present invention has been described with respect to certain preferred embodiments, it will be apparent to those skilled in the art that various changes and modifications may be made without departing from the scope of the invention as defined in the following claims.

1. A cable control apparatus for preventing a plurality of cables, which are rotatably connected to an arm and a head of an industrial robot, from being loosen or damaged by the operation of the head, the cable control apparatus comprising:
a body disposed above the arm and having a male rail formed in a length direction;
a stationary unit fixed at an upper onside of the body and having a through-hole;
a moving unit disposed on the male rail slidably in right and left directions and including a through-hole formed thereon and a female rail corresponding to the male rail;
a cable tube for integrally housing a plurality of the cables and including one end fixed to the moving unit and the other end connected to the head through the through-hole of the stationary unit; and
an elastic member externally inserted to the cable tube and including one end connected to the stationary unit and the moving unit for returning the moving unit to an original position using elastic force when the head of the industrial robot slides the moving unit connected to the cable tube.

2. The cable control apparatus of claim 1, wherein a rail protrusion is formed on the male rail in a length direction and a rail groove is formed on a bottom side of the arm rail in a length direction to be corresponding to the rail protrusion.

3. The cable control apparatus of claim 1, wherein one or more male rails are disposed above a bottom side of the body at a predetermined distance, and the female rail includes at least one of through-holes formed under the female rail to slidably move while surrounding a cross-section of the male rail.

4. The cable control apparatus of claim 1, wherein the elastic member is a spring.

5. The cable control apparatus of claim 1, further comprising a sub stationary unit disposed at an upper one side of the body and having a through-hole,
wherein the sub station unit makes a plurality of the cables to be bended in about a ‘U’ shape after the cables pass through the stationary unit and the moving unit straightly in order to prevent the cables from being shaken by the operation of the head.

6. A cable control apparatus for preventing a plurality of cables, which are rotatably connected to an arm and a head of an industrial robot, from being loosen or damaged by the operation of the head, the cable control apparatus comprising:
a body disposed above the arm and having a male rail formed in a length direction;
a stationary unit fixed at an upper onside of the body;
a moving unit disposed on the male rail slidably in right and left directions and including a through-hole formed thereon and a female rail corresponding to the male rail;
a cable tube for integrally housing a plurality of the cables and including one end fixed to the moving unit and the other end connected to the head of the industrial robot;
a supporting member fixed at an upper one side of the body and having a through-hole to allow the cable tube to pass through; and
an elastic member including one end connected to the stationary unit and the moving unit for returning the moving unit to an original position using elastic force when the head of the industrial robot slides the moving unit connected to the cable tube.
